(19) United States
(12) Patent Application Publication
(10) Pub. No.: US 2019/0090687 A1
(43) Pub. Date: Mar. 28, 2019

(54) COLLAPSIBLE PANS

(71) Applicants: Jennifer Seay, Girardeau, MO (US); Roger Seay, Girardeau, MO (US)

(72) Inventors: Jennifer Seay, Girardeau, MO (US); Roger Seay, Girardeau, MO (US)

(21) Appl. No.: 15/713,180

(22) Filed: Sep. 22, 2017

(51) Int. Cl. A47J 36/02; B65D 6/26; B65D 8/00; B65D 6/02

(52) U.S. Cl. CPC A47J 36/02; B65D 7/06; B65D 7/04; B65D 7/30

(57) ABSTRACT

A collapsible baking pan is provided that may provide for a center base portion that may be hingedly connected to at least three side portions. In some embodiments, one or more side elements may be connected to one or other side elements via a latch having a clamp and a hook.

### CROSS-REFERENCE TO RELATED APPLICATION

Not applicable.

### TECHNICAL FIELD

The present invention relates generally to the field of baking pans and more specifically relates to a collapsible baking pan.

### BACKGROUND

Many people enjoy baking. However, many people do not enjoy getting the baked good out of the baking pan. This is because, due to the nature of most baked goods, the baked treat adheres to the sides of the pan. As such, cutting, scooping, or even scraping is often required to remove the item from the baking pan. In turn, such actions not only cause the baked good to lose its appealing shape, but also take a toll on the pan. Knife marks, dents, or scrapes can cause the pan to not only become unsightly, but to deform and perform less effectively.

Additionally, as previously mentioned, many baked goods can lose their shape when transferred from the baking pan to a serving plate or dish, such transfer can be perilous.

What is needed therefore is a baking pan wherein the pan's sides detach from one another and lay flat. This would not only make cutting and distributing the baked item easier, but would also enable the baker to serve the baked good directly from the baking pan quickly and easily.

Various attempts to solve this problem have been made. One such attempt can be seen with respect to U.S. Pat. No. 5,253,802, incorporated by reference in its entirety herein, which generally discloses a foldable baking pan suitable for microwave use. While this disclosure does generally provide for a foldable pan suitable for cooking or baking, its cardboard design and multiple folding requirements make it unsuitable for repeated baking endeavors.

Another attempt can be seen with respect to U.S. Design Pat. No. 738,157 S1, incorporated by reference in its entirety herein, which generally discloses a foldable baking pan having interlocking edges. While this disclosure does provide for an foldable baking pan, its interlocking design fails to provide for the dependability of a clamp-clasp that keeps the end pieces properly and tightly connected.

Yet another interesting attempt can be seen with respect to U.S. Pat. No. 3,771,713, incorporated by reference in its entirety herein, which generally discloses a sectional pie pan wherein a user may remove part of the pan corresponding with an individual slice. While this disclosure does enable easier cutting and serving of a pie, its shape is limited to pies and the sides of the disclosure do not fold down.

Yet another attempt can be seen with respect to U.S. Patent Application Publication No. 2012/0024865, incorporated by reference herein, which generally discloses a spring-release barrier atop a baking pan. While this disclosure does provide for a removable edge, its springform design makes it difficult to control the manner and shape of which the sides release.

Yet another attempt can be seen with respect to U.S. Patent Application Publication No. 2010/0288779, which generally discloses pan sides connected to a base and that can be released or connected as necessary. Although this disclosure does provide for secure side piece attachment, the continuous material linking the side pieces, rather than enabling them to completely disconnect, prevents a clean separation from the baked good and makes cleaning the pan very difficult.

Various attempts have been made to solve the problems which may be found in the related art but have thus far been unsuccessful. A need exists for a new collapsible baking pan to avoid the above-mentioned problems.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

The present invention relates to a collapsible baking pan that overcomes the deficiencies of the prior art. It is contemplated that the present invention may provide for a collapsible baking pan so as to enable easier cutting and serving of baked goods.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel baking pan. The general purpose of the present invention, which will be described subsequently in greater detail, is to provide a user with the ability to bake, cut, and serve baked goods quickly and easily. The features of the invention which are believed to be novel are particularly pointed out and distinctly claimed in the concluding portion of the specification. These and other features, aspects, and advantages of the present invention will become better understood with reference to the following drawings and detailed description.

In one embodiment, the present invention may provide for a baking pan that collapses to fold flat. It is contemplated that the baking pans will fold flat (one piece) for easy serving and storage. The present invention will also provide a one-pan option that enables both baking and serving.

The present invention may provide for pans that may have hinges on the bottom of the center piece, as well in some embodiments on one end of each side piece. The side pieces may provide for latches on the sides for securing the side pieces, and therefore the center pieces, together while in the baking position. These side latches will, when left open, allow for flat and space saving storage and easy serving.

It is contemplated that the present invention's pans will prevent knife marks on the interior of the pans, as well as provide a clean cutting surface after baking. The present invention's pans will also alleviate the need for an additional serving plate. One stop and less clean up. The present invention's pans will also, when in the down position, will allow for a more compact storage ability and space-saving. The present invention's baking pans will typically not take up a large amount of space.

The unique features of the present invention may provide the following benefits for one or more consumers: the present invention's pans may flatten for space saving, eliminate unsightly knife marks, prevent beaten up misshapen pans, enable easy brownie and bread removal, make every edge of a baked good delicious, enable the baked good to have clean and sharp edges, and prevents the baked good from having weird side or corner pieces.

In some embodiments, the present invention may comprise a pan having a base element, at least three side elements hingedly connected to the base element, wherein each side element has an inside side and an outside side, and at least one latch configured to detachably connect at least one side element to at least one other side element. In some embodiments, the pan may be aluminum, and the latch may be aluminum. In some embodiments, the pan's base may be raised. In some embodiments, the latch may be a two-part latch having a clamp portion and a hook portion and wherein the hook portion is fixedly connected to the outside side of a side element and the clamp portion is fixedly connected to the outside side of another side element, and wherein the latch is configured to detachably connect the clamp portion to the hook portion. In some embodiments, the present invention may provide for four side elements. In some embodiments, the pan may be circular, so as to accommodate a pie-shaped baked good.

In some embodiments, the present invention may also provide for a rack configured to store one or more pans of the present invention, pans shaped as muffin pans, bread pans, casserole pans, cake pans, star-shaped pans, or any other shaped pan. Additionally, the present invention may be shaped as a lid or other baking accessory.

### BRIEF DESCRIPTION OF THE DRAWINGS

These and other features, aspects and advantages of the present invention will become better understood with regard to the following description, appended claims, and accompanying figures where:

FIG. 1 shows a top perspective view of a collapsible baking pan in accordance with one embodiment of the invention.

FIG. 2 shows a close up perspective view of a collapsible baking pan in accordance with one embodiment of the invention.

FIG. 3 shows a top perspective view of a collapsible baking pan in accordance with one embodiment of the invention.

FIG. 4 shows a top perspective view of a collapsible baking pan in accordance with one embodiment of the invention.

FIG. 5 shows a bottom perspective view of a collapsible baking pan in accordance with one embodiment of the invention.

### DETAILED DESCRIPTION

The present invention overcomes the limitations of the prior art by providing a new and more effective collapsible baking pan.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well known features, elements or techniques may not be shown in detail in order not to obscure the embodiments.

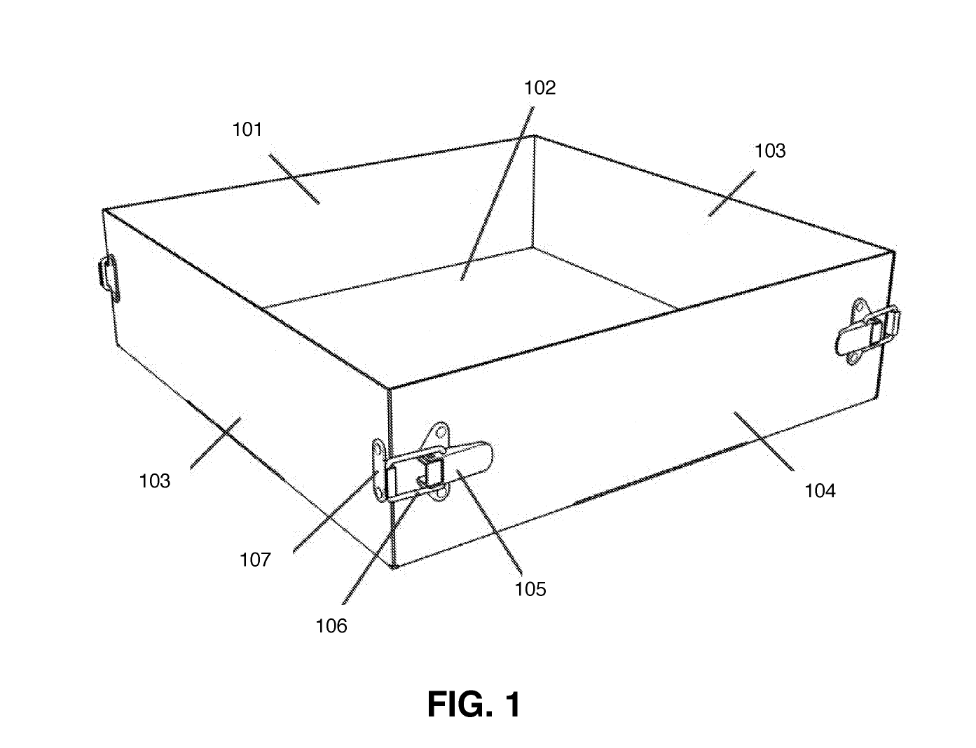

Turning attention to FIG. 1, a top perspective view of a collapsible baking pan in accordance with one embodiment of the invention is shown. In the embodiment depicted, a viewer may perceive baking pan 101 (which may be aluminum), raised platform base 102, clamp side 103, hook side 104, latch 105 (which may be aluminum), and clamp hook 106.

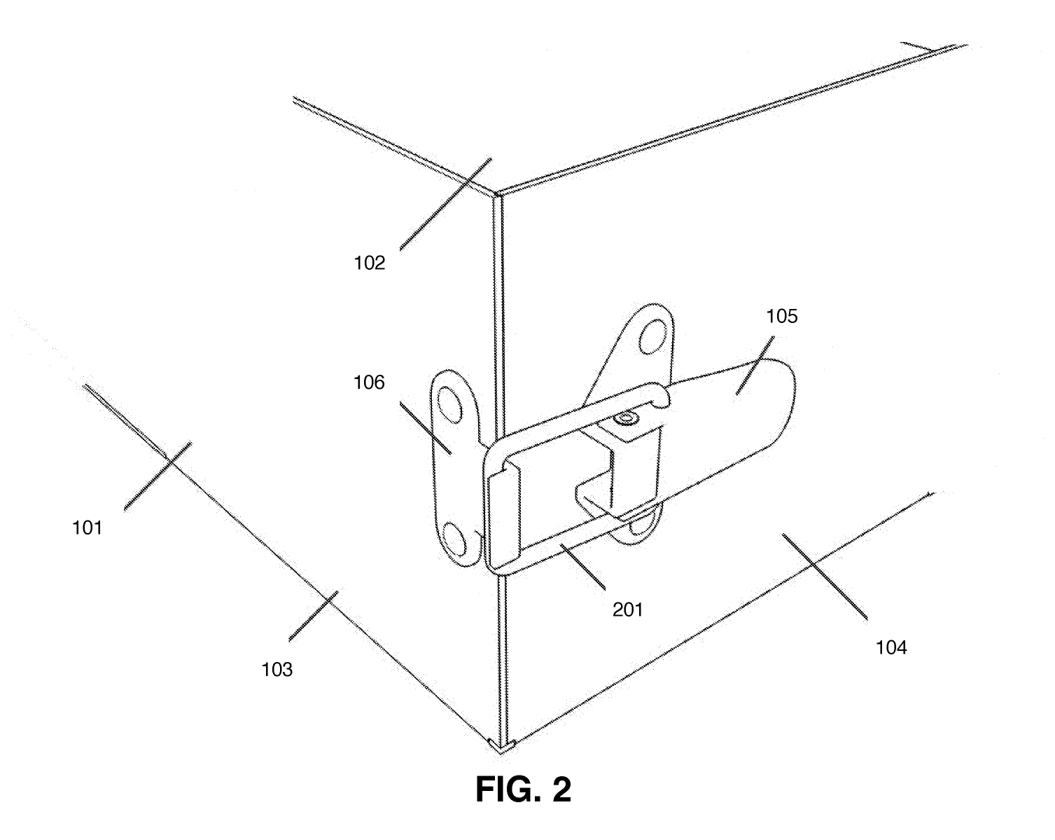

With respect to FIG. 2, a close up perspective view of a collapsible baking pan in accordance with one embodiment of the invention is shown. In the embodiment depicted, a viewer may perceive clamp 201, as well as baking pan 101 (which may be aluminum), raised platform base 102, clamp side 103, hook side 104, latch 105 (which may be aluminum), and clamp hook 106.

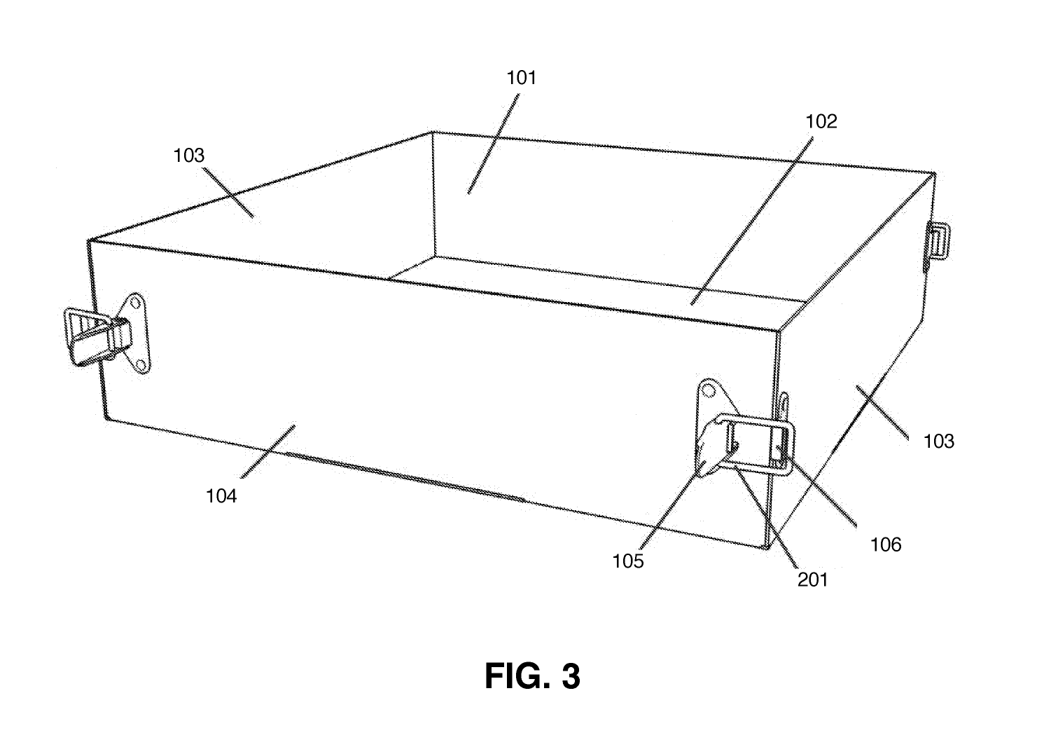

With respect to FIG. 3, a top perspective view of a collapsible baking pan in accordance with one embodiment of the invention is shown. In the embodiment depicted, a viewer may perceive baking pan 101 (which may be aluminum), raised platform base 102, clamp side 103, hook side 104, latch 105 (which may be aluminum), clamp hook 106, and clamp 201.

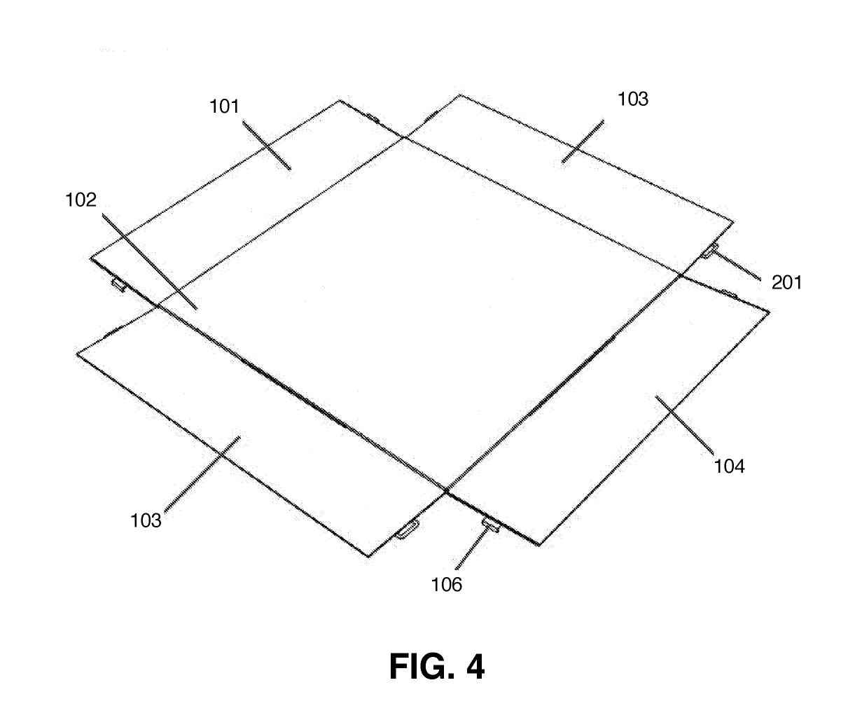

With respect to FIG. 4, a top perspective view of a collapsible baking pan in accordance with one embodiment of the invention is shown. In the embodiment depicted, a viewer may perceive baking pan 101 (which may be aluminum), raised platform base 102, clamp side 103, hook side 104, clamp hook 106, and clamp 201.

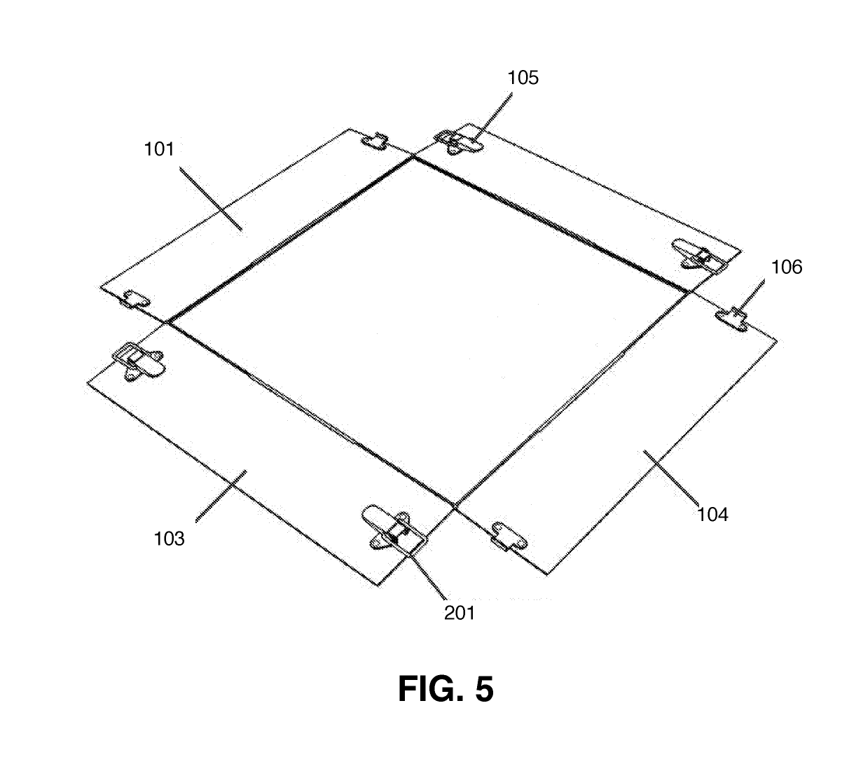

With respect to FIG. 5, a bottom perspective view of a collapsible baking pan in accordance with one embodiment of the invention is shown. In the embodiment depicted, a viewer may perceive baking pan 101 (which may be aluminum), clamp side 103, hook side 104, latch 105 (which may be aluminum), clamp hook 106, and clamp 201.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the collapsible baking pan generally described herein has been disclosed in connection with a number of embodiments shown and described in detail, various modifications should be readily apparent to those of skill in the art.

What is claimed is:

1. A pan comprising:
a base element;
at least two side elements hingedly connected to the base element, wherein each side element has an inside side and an outside side; and
at least one latch configured to detachably connect at least one side element to at least one other side element.

2. The pan of claim 1, wherein the base is aluminum.

3. The pan of claim 1, wherein the latch is aluminum.

4. The pan of claim 1, wherein the base is raised.

5. The pan of claim 1, wherein the at least one latch is a two-part latch, having a clamp portion and a hook portion, and wherein the hook portion is fixedly connected to the outside side of a side element and the clamp portion is fixedly connected to the outside side of another side element, and wherein the latch is configured to detachably connect the clamp portion to the hook portion.

6. The pan of claim 1 having four side elements.

7. The pan of claim 1 wherein the pan is circular.
